(19) United States
(12) Patent Application Publication
(10) Pub. No.: US 2026/0201930 A1
(43) Pub. Date: Jul. 16, 2026

(54) INCLINED HOLE FOR AIR INLET

(71) Applicants: TALLANO TECHNOLOGIES, PARIS (FR); AKWEL, CHAMPFROMIER (FR)

(72) Inventors: Loïc ADAMCZAK, PARIS (FR); Adrien MAISTRE, PARIS (FR)

(73) Assignees: TALLANO TECHNOLOGIES, PARIS (FR); AKWEL, CHAMPFROMIER (FR)

(21) Appl. No.: 19/134,774

(22) PCT Filed: Oct. 28, 2023
(86) PCT No.: PCT/FR2023/051707

§ 371 Date: Jun. 2, 2025

(30) Foreign Application Priority Data
Dec. 2, 2022 (FR) FR2212695

(51) Int. Cl. F16D 65/00; F16D 65/092; F16D 69/00

(52) U.S. Cl. CPC F16D 65/0031; F16D 65/092; F16D 2069/004

(57) ABSTRACT

A disk pad including a backing plate with an inner surface and a lining fixed to the inner surface, where the lining includes a collection groove open on the friction surface of the lining, where the backing plate includes an aspiration hole in fluid communication with this groove and connected to a vacuum source. The collection groove is extended at one of the ends thereof by a conduit whose outer end opens outside the friction surface, and where the conduit forms a section break with the groove. The angle of inclination between the axis of the conduit and the longitudinal axis of the groove is nonzero and is inclined such that the airflow near the friction surface of the lining is not perpendicular to the friction surface.

### FIELD

The present invention relates to nonpolluting braking systems, intended to be used in machines comprising a rotary element whose rotation one wants to slow, such as for example highway vehicles (cars, buses, trucks) or railway vehicles, and windmills. In such braking systems, particles and dust are emitted by the friction braking as a result of the abrasion of the brake pads against the rotary element. This rotary element is for example the wheel of the vehicle, or a disk driven by the wheel of the vehicle. It is known that these particles dispersed in the ambient environment are harmful to the health of individuals. Further, the progression of electric motorization for automotive vehicles has increased the need for treating particles and dust resulting from abrasion of friction braking systems.

### BACKGROUND

There is therefore a need to capture these particles and dust before they are released into the ambient environment. For this purpose, a means consists of providing the lining of the disk-brake or brake-shoe pad with a groove which is connected to a vacuum source, where the particles are then evacuated and aspirated in this groove.

Thus a brake pad 10 in a disk brake is known, where the pad comprises a backing plate 1 with an outer surface 14, an inner surface 13 and a lateral edge 11, and a lining 2 of friction material fixed to the inner surface 13, and where the lining 2 is delimited by a friction surface 26, an attachment surface 20, and a lateral edge formed of an inner edge 23, and outer edge 24, a rear edge 21 and a front edge 22. The lining 2 is provided with a collection groove 3 which is open on the friction surface 26 and which is located near the rear edge 21, where the backing plate 1 comprises an aspiration hole 17 having a fluid connection with the collection groove 3. The aspiration hole 17 is connected to a vacuum source via fluid connection means.

However, during operation a decrease in aspiration performance develops as the wear of the lining progresses. In fact, the wear leads to an increase of the linear load losses, the load losses forcing a reduction of flow rate of the vacuum source (for example a turbine). The result of this situation is a reduction in the performance of the process of capturing particles and dust by the collection groove.

For the capture performance to remain constant despite the wear of the lining 2, a brake pad is known, as described in the document FR 3,087,238, wherein the collection groove 3 is extended at one of the ends by a straight conduit 90 whose outer end 91 opens outside of the friction surface 26 through an inlet 911 and whose inner end 92 opens into the collection groove 3 by an outlet 922 which forms a section break with the groove 3.

Such a pad is shown in FIGS. 13 to 16. The conduit 90 acts such that there is, in operation, a reduced pressure between the inlet of the conduit 911 and the collection groove 3 on either side of the conduit 90.

In an option, the conduit 90 extends parallel to the friction surface 26 and to the inner surface 13 and opens into the lateral edge, for example onto the lateral edge 23, as shown in FIGS. 13 to 15. FIG. 13 is a top view of the pad. FIG. 14 is a perspective view of the pad. FIG. 15 is a section view along the groove 3 from FIG. 14.

In another option, the conduit 90 extends perpendicularly to the friction surface 26 and to the inner surface 13 and opens through the backing plate and opens on the outer surface 14, as shown in FIG. 16. This solution has the advantage that the conduit 90 may be drilled in the backing plate 1 during the fabrication thereof, and it is not necessary to form the conduit 90 in the lining 2. The fabrication of the pad 10 is therefore simplified and the cost thereof is reduced.

Thus, a brake pad is known where the pad comprises a backing plate with an outer surface, an inner surface and a lateral edge, and a lining of friction material fixed to the inner surface, where the lining is delimited by a friction surface, an attachment surface, and a lateral edge formed of an inner edge, an outer edge, a rear edge, and a front edge, where the lining is provided with at least one collection groove open to the friction surface and located at least in part near the rear edge, where the backing plate comprises at least one aspiration hole in fluid communication with the at least one collection groove, where the at least one aspiration hole is connected to a vacuum source via fluid communication means, where the at least one collection groove is extended at at least one of the ends thereof by a conduit whose outer end opens outside the friction surface by an inlet, and whose inner end opens into the at least one collection groove by an outlet which forms a section break with the at least one groove such that there exists, in operation, a reduced pressure between the inlet of the conduit and the at least one collection groove through the conduit.

As explained above, the aspiration and capture of brake particles in the braking system described above are done by generating an airflow which passes into the collection groove. Tests done by the inventors show that the greater the air speed near the surface of the disk (or of the wheel), the better the effectiveness of the capture of particles. This means that the faster the speed of the air along the friction surface of the lining, and therefore the faster the airflow rate, the more effective the aspiration of the particles.

However to limit load losses and therefore the power of the aspiration source, the airflow rate passing into the groove must be reduced. There are therefore two competing needs.

### SUMMARY

The invention aims to propose a brake pad which serves to increase the speed of the air along the friction surface of the lining without having to increase the flow rate passing in the collection groove.

This goal is achieved because the angle of inclination between the axis of the conduit and the longitudinal axis of the groove is nonzero and is inclined such that the airflow near the friction surface of the lining is not perpendicular to the friction surface.

Because of these arrangements, the airflow which passes in the groove has a velocity distribution with height in the groove which is maximal along the friction surface of the lining. The aspiration of particles in the groove is thus optimized.

For example, the angle of inclination is broken down into a primary angle in a plane perpendicular to the plane of the friction surface and a secondary angle in the plane of the friction surface, where the primary angle is measured positively from the plane of the friction surface towards said backing plate on the outside of the groove around the outlet and where the primary angle is included in the interval ]0°, 135°].

For example, the secondary angle is zero.

For example, the outer end opens from the side of one of the edges.

For example, the conduit passes through the backing plate, where the outer end opens on the outer surface or on the lateral edge of the backing plate.

For example, the at least one collection groove is made up of a single groove which follows the rear edge.

For example, the collection groove further follows the front edge.

For example, the collection groove has a C shape or an E shape or circumferential shape and follows along the outer edge and/or the inner edge.

For example, the angle of inclination is broken down into a primary angle in a plane perpendicular to the plane of the friction surface and a secondary angle in the plane of the friction surface, where the secondary angle is measured positively to the outside of the groove from the plane in the trigonometric direction around an axis oriented from the bottom of the groove towards the top, and where the secondary angle is nonzero and included between −90° and 90°.

For example, the secondary angle is negative.

### BRIEF DESCRIPTION OF THE FIGURES

The invention will be better understood and its advantages seen more clearly by reading the following detailed description of embodiments shown as nonlimiting examples. The description refers to the attached drawings on which:

FIG. 1 is a perspective view of a brake pad according to the invention;

FIG. 2 is a section view along the collection groove of a brake pad according to the invention, along the line II-II from FIG. 1;

FIG. 3 is a section view along the collection groove of a brake pad according to another embodiment of the invention, with a conduit which opens on the lateral edge of the backing plate;

FIG. 4 is a section view along the collection groove of a brake pad according to yet another embodiment of the invention, with a conduit which opens on the outer surface of the backing plate with a primary angle strictly less than 90°;

FIG. 5 is a section view along the collection groove of a brake pad according to yet another embodiment of the invention, with a conduit which opens on the outer surface of the backing plate with a primary angle strictly greater than 90°;

FIG. 6 is a perspective view of a braking system comprising a brake pad according to the invention;

FIG. 7 shows the airflow passing in the groove for various values of the primary angle of the conduit of a brake pad according to the invention;

FIG. 8 shows a brake pad according to the invention in the case where the primary angle of the conduit is equal to 45°, with a secondary angle θ which is equal to 0°, 45° or 90°;

FIG. 9 shows the airflow passing in the groove for a primary angle equal to 45° and a secondary angle equal to −50°;

FIG. 10 shows the airflow passing in the groove for a primary angle equal to 45° and a secondary angle equal to 45°;

FIG. 11 is a perspective view of a brake pad according to another embodiment of the invention, with a C-shaped groove and a conduit at each end of the groove;

FIG. 12 is a top view of a brake pad according to yet another embodiment of the invention;

FIG. 13, already described above, shows a pad according to the prior art in top view;

FIG. 14, already described above, shows a pad according to the prior art in perspective view;

FIG. 15, already described above, is a section view along the collection groove of the brake pad from FIG. 14, along the line XV-XV from FIG. 14;

FIG. 16, already described above, is a section view along the collection groove of a variant of the brake pad from FIG. 14.

### DETAILED DESCRIPTION

The present invention relates to a brake pad 10 in the braking device of a rotary element 9 of a machine. The invention is described below in the case where the machine is a road vehicle where this brake is a disk brake. However, the invention applies just as well to the case of a brake pad in a brake shoe which rubs on a wheel, used in vehicles on rails (railway), or to the case of a brake pad used in any other industrial machine (for example in the case of a windmill). In all cases, braking a rotary element of the machine is done by friction of the brake pad on this rotary element during rotation thereof.

In a disk brake, braking is performed by a friction between the disk (which is the rotary element 9) which is secured to a wheel of the vehicle, and two brake pads 10 which are pressed onto either side of the disk 9 in order to sandwich it. The disk 9 extends in a principal plane and has as an axis of rotation an axis A which is perpendicular to this principal plane. Each of the pads 10 extends in this principal plane such that the thickness of the pad 10 extends along the axis of rotation A.

The disk 9 turns around the axis of rotation A with a direction of rotation FW, which defines a tangential direction T which is tangent to the circumference of the disk 9 and oriented in the direction of rotation FW, and a radial direction R orthogonal to the axis of rotation A in the principal plane of the disk 9. These elements are indicated on FIG. 6, which shows the braking device mounted on the disk 9.

In the following description, the terms “inner” and “outer” designate the edges or zones of the brake pad 10 (or of the components thereof) which are respectively located closest to and farthest from the axis of rotation A, and the terms “front” and “rear” designate the edges or zones of the brake pad 10 (or of the components thereof) which are located respectively upstream and downstream relative to the direction of movement of the particles 28 released by the lining 2 (described below) which is also the direction of rotation FW.

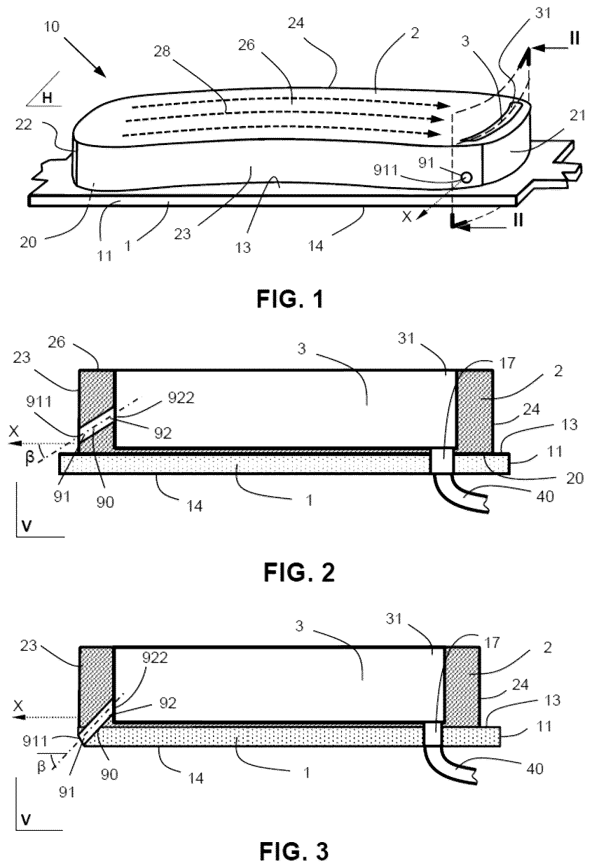

As shown in FIGS. 1 and 2, a brake pad 10 comprises a backing plate 1 also called base. The backing plate 1 is for example made of metal. The backing plate 1 is a flat plate of substantially constant thickness (for example between 3 and 5 mm) whose general shape in the principal plane thereof is trapezoidal with straight or curved edges. The backing plate 1 comprises an inner surface 13 on which is attached a lining 2, and an outer surface 14 which is opposite and parallel to the inner surface 13. These two surfaces are joined by a lateral edge 11.

The brake pad 10 further comprises a lining 2 made of a friction material. For example, this material is a material called “ferodo.” The lining 2 is delimited by a friction surface 26 (“rubbing” surface), an attachment surface 20 opposite the friction surface 26, (these two surfaces being parallel to one another) and fixed to the backing plate 1, an inner edge 23, and outer edge 24, a rear edge 21 and a front edge 22. The outer 24, rear 21 and front 22 edges are convex or straight, and the inner edge 23 is concave or straight.

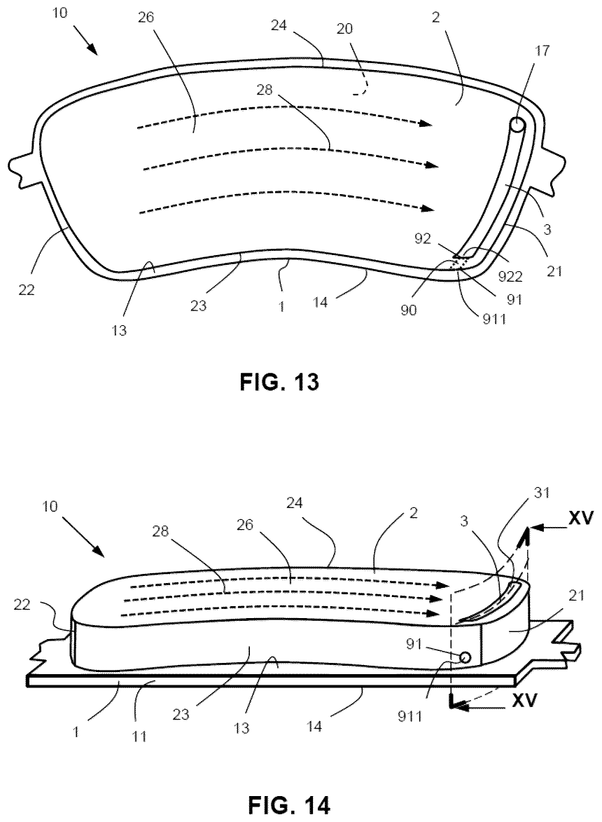

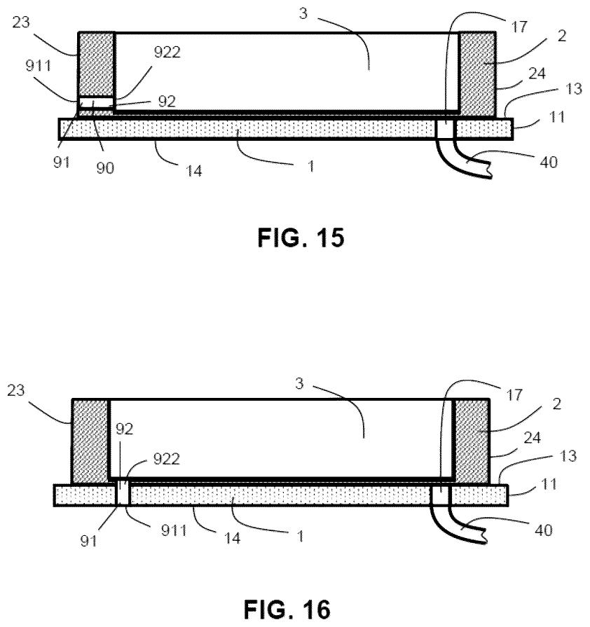

The friction surface 26 comes progressively closer to the backing plate 1 as the lining 2 wears away. The thickness of the lining 2 (measured along the axis of rotation A) consequently gets thinner with wear thereof. During operation, the lining 2 (and the rotary element 9) releases particles 28 because of friction between the lining 2 and the disk 9. The trajectories of the particles 28 along the friction surface 26 are shown as dashed lines on FIG. 1 (and also on FIGS. 13 and 14).

The lining 2 is provided with at least one collection groove 3 open on the friction surface 26, and which is located near the rear edge 21.

For example, the surface area of the part of the friction surface 26 which is located between the rear edge 21 and the groove 3 is less than 10% of the entire surface area of the friction surface 26.

The depth of the one or more grooves 3 is less than the height of the lining 2 (measured perpendicularly to the plane of the friction surface 26), meaning that some lining 2 remains between the bottom of each groove 3 and the inner surface 13 of the backing plate 1. The distance between the bottom of each groove 3 and the inner surface 13 (measured perpendicularly to this inner surface 13) is called “residual height” and is for example equal to 20% of the initial height (before wear) of the lining 2. This residual height is for example equal to 10% of this initial height. This residual height is for example equal to 5% of this initial height. This residual height is for example equal to 1% of this initial height.

Alternatively, the depth of the one or more grooves 3 is equal to the height of the lining 2, meaning that the bottom of the one or more grooves 3 coincides with the inner surface 13 of the backing plate 1.

Alternatively, the depth of the one or more grooves 3 is greater than the height of the lining 2, meaning that the bottom of this or these grooves 3 is located in the thickness of the backing plate 1 (in other words the bottom of this or these grooves 3 is a throat which is hollowed in the backing plate 1, without opening out onto the outer surface 14 except pointwise (see below)).

The collection groove 3, or at least one of the collection grooves 3, extends at least in part along the rear edge 21 and is straight or follows the curve of the rear edge 21. The smallest dimension of the groove 3 is the thickness thereof, measured in the main plane of the pad 10, substantially in the tangential direction T.

For example, the one or more collection grooves 3 have a rectangular section that is constant from the upstream end thereof to the downstream end thereof and therefore have a constant thickness.

The lining 2 is for example provided with a single continuous groove, substantially straight or having one or more bends between two or more substantially straight portions.

Alternatively, the lining 2 is provided with a plurality of collection grooves 3 which are pairwise disjoint. Disjoint grooves means that the grooves do not connect with each other except, possibly, through a conduit 90, as described below.

Thus, in the present invention, either the lining 2 has a single collection groove 3 (only groove), or the lining 2 has a plurality of disjoint collection grooves 3. For example, the lining 2 comprises, in addition to a collection groove 3 located near the rear edge 21, a second collection groove 3 (open on the friction surface 26). For example, this second groove 3 is located midway between the rear edge 21 and the front edge 22 and extends from near the inner edge 23 to near the outer edge 24, while optionally opening on the inner edge 23 or the outer edge 24.

In summary, according to the invention, the lining 2 is provided with (has) at least one collection groove 3, and this at least one collection groove 3 is either made up of a single collection groove of which at least one portion follows the rear edge 21, or made up of a plurality of disjoint grooves including one first groove 3a which follows the rear edge 21.

In the case of a single collection groove 3, this groove comprises a single straight or curved portion, or several straight or curved portions connected by bends for forming a network of joined groove portions. The collection groove 3 is then convex.

An airflow is created in the collection grooves 3, where this airflow 10 is generated by a vacuum source (aspiration system), as described below.

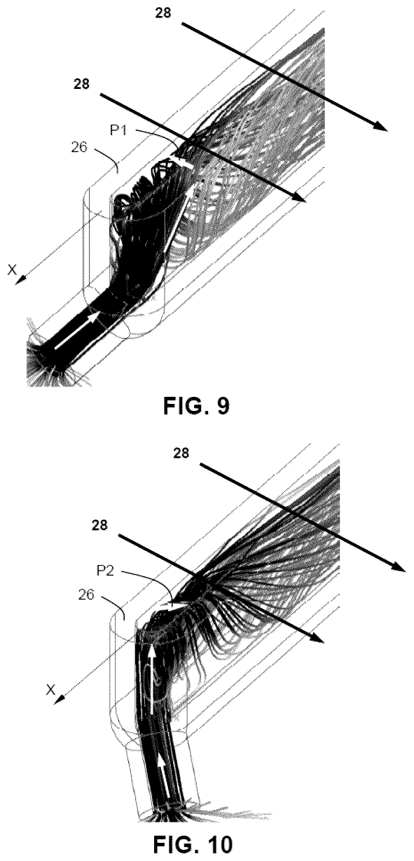

In the following part of the description, referring to FIGS. 1 to 5, the case is described where there is a single collection groove 3 that is extended at one of the ends thereof by a conduit 90 (see below) which opens from the side of the lower edge 23. The invention applies similarly to the case where the collection groove 3 opens from the side of the outer edge 24. FIG. 8 and FIG. 9 also show the case where a collection groove 3 extends to one of the ends thereof by a conduit 90 which opens from the side of the inner edge 23. This groove 3 is not necessarily the only one; there may exist at least one other groove 3 in the lining 2 (not shown on these figures).

“The conduit 90 opens from the side of one edge” means that the conduit 90 is open at one of the ends thereof near the edge, meaning either through the backing plate 1 or directly on this edge.

In every case, a conduit 90 opens from one of the ends thereof outside of the friction surface 26. A conduit 90 opens therefore either on an edge (21, 22, 23, 24), or through the backing plate 1, or into another groove.

As shown in FIGS. 1 and 2, and in FIGS. 3 to 5, the collection groove 3 is for example a groove which follows along the rear edge 21, having a first end and a second end. The longitudinal axis X of the groove 3 is defined as the axis which is parallel to the plane H of the friction surface 26 and along which the groove 3 starts to extend from the first end thereof. If the groove 3 is straight, the longitudinal axis X therefore extends from the first end to the second end of the groove 3, and the plane V of the groove 3 is the plane perpendicular to the friction surface 26 in which the groove 3 extends. If the groove 3 is curved, the plane V is defined as being the plane in which the groove 3 starts to extend at the first end thereof. Thus, in every case the plane V of the groove 3 contains the longitudinal axis X.

Near the outer edge 24, the groove 3 ends at the second end thereof at a blind end 31, which does not open on the outer edge 24.

Near this blind end 31, the backing plate 1 comprises a through aspiration hole 17 which opens in the groove 3. This aspiration hole 17 is visible in FIG. 2. Thus, the particles 28 aspirated in the groove 3 pass into the aspiration hole 17 then into a hose 40 which is part of the aspiration system. The air loaded with these particles 28 passes from the groove 3 to the aspiration hole 17 (fluid connection). At one end thereof, the hose 40 is connected to the aspiration hole 17. These elements can be seen in FIG. 2.

The hose 40 is connected to an aspiration mechanism (not shown) which is part of the aspiration system, and which is able to aspirate the particles 28 from the groove 3 through the hose 40.

The collection groove 3 is extended near the first end thereof by a conduit 90. The conduit 90 is made up of a continuous lateral wall connecting two ends, and is only open at these two ends. The conduit 90 thus forms a tunnel. This tunnel is straight and the axis of the conduit 90 is therefore straight, which allows drilling thereof. Alternatively, the tunnel is curved. In this case, the axis of the conduit 90 is defined as the axis along which the conduit 90 starts to extend from the collection groove 3 (meaning from the inner end 92 of the conduit 90, see definition below).

Advantageously, as is the case when the conduit 90 is drilled, the section of the conduit 90 remains constant throughout the life of the pad 10 and the performance for aspiration of the particles 28 by the collection groove is maintained.

The conduit 90 opens at its outer end 91 from the side of the inner edge 23 by an inlet 911. The conduit 90 opens at its inner end 92 in the collection groove 3 by an outlet 922. The outlet 922 forms a section break with the groove 3, meaning the section increases abruptly (step-like) on passing from the conduit 90 to the groove 3.

The section increase is visible on FIG. 2 which is a section along the line II-II from FIG. 1, meaning the full length of the collection groove 3 and the conduit 90 from the inner edge 23 to the outer edge 24.

Because of this abrupt section increase (in the normal direction of the airflow), there exists, in operation, a reduced pressure between the inlet 911 and the collection groove 3 on each side of the conduit 90, meaning along the conduit 90.

Further, according to the invention, the axis of the conduit 90 makes a nonzero angle δ with the longitudinal axis X of the groove 3. The angle δ is called angle of inclination and is shown on FIG. 8. Thus, in the general case, the angle of inclination δ breaks down into a primary angle β in a vertical plane (for example the plane V) perpendicular to the plane of the friction surface 26 (plane H) and a secondary angle δ in the plane H of the friction surface 26.

In a specific case, the secondary angle δ is zero, and the conduit 90 is inclined solely in the plane V of the groove 3 according to the primary angle β.

In another specific case, the primary angle β is zero, and the conduit 90 is inclined solely in a plane parallel to the plane H of the friction surface 26 according to the secondary angle θ.

The primary angle β is measured positively from the plane H of the friction surface 26 towards the backing plate 1 to the outside of the groove 3 around the outlet 922. The primary angle β is always positive. Thus, the air which passes in the conduit 90 from the inlet 911 towards the outlet 922 is always directed towards the friction surface 26, except for the other specific case mentioned above. In fact, in this other specific case, the primary angle β is zero and a secondary angle θ is nonzero and therefore the air leaves the conduit 90 in a plane parallel to the plane H of the friction surface 26.

The secondary angle θ is measured positively to the outside of the groove 3 from the plane V (in the plane H) in the trigonometric direction around an axis oriented from the bottom towards the top of the groove 3.

In the case where the conduit 90 is straight, the axis of the conduit 90 is the straight line which connects the center of the inlet 911 and the center of the outlet 922. In the case where the conduit 90 is curved, the axis of the conduit 90 is taken to be the tangent to the curve connecting the centers of the transverse sections of the conduit 90 at the center of the outlet 922.

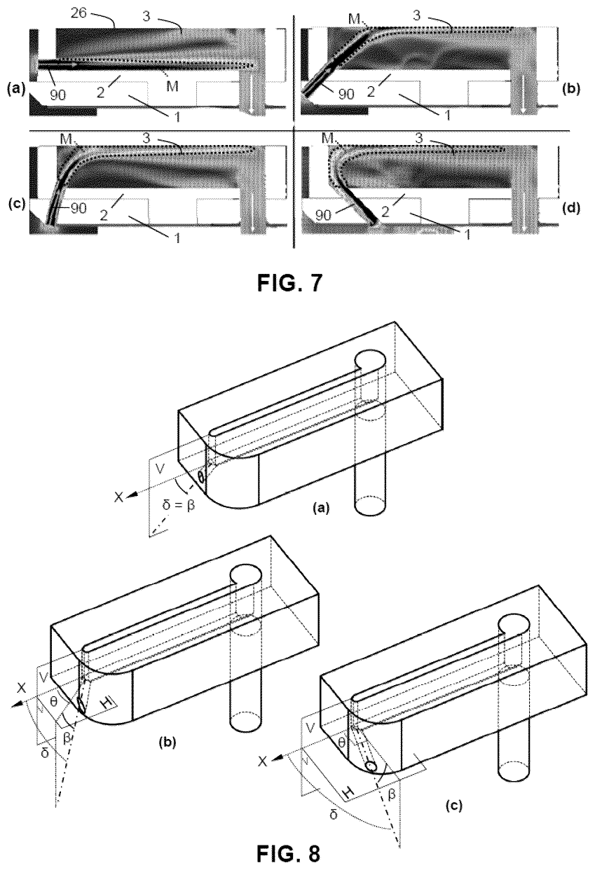

In the specific case where the secondary angle θ is zero, meaning that the conduit 90 is inclined solely in the plain V of the groove 3 along the primary angle β, the existence of a strictly positive (and therefore nonzero) primary angle β means that the airflow which passes in the groove 3 on leaving the conduit 90 has a velocity distribution with height of the groove 3 which is maximal along the friction surface 26 of the lining. Surprisingly, this distribution was experimentally observed by the inventors. FIG. 7 shows the resulting velocity distribution with a zero angle of inclination δ (FIG. 7 (a)), with an angle of inclination δ where the primary angle β is equal to 45° and the secondary angle θ is zero (FIG. 7 (b)), with an angle of inclination δ where the primary angle β is equal to 75° and the secondary angle θ is zero (FIG. 7 (c)), and with an angle of inclination δ where the primary angle β is equal to 135° and the secondary angle θ is zero (FIG. 7 (d)). Zone M of the groove 3 where the velocities are maximal is surrounded by a dashed curve. Note that in the case (a) (no inclination of the conduit 90) the zone M is at the bottom of the groove 3, meaning near the inner surface 13. In contrast, in the cases (b), (c) and (d) with an inclination of the conduit 90 in the plane V of the groove 3, the zone M is located along the friction surface 26.

Tests done by the inventor show that the results shown in FIG. 7 involving the longitudinal velocity (along the longitudinal axis X) near the friction surface 26 in the case where the secondary angle θ is zero remain qualitatively the same for all values of the secondary angle 0 (meaning between −90° and 90°). Thus, this longitudinal velocity varies between two values of the secondary angle θ (in absolute value), but this longitudinal velocity is the same for two opposite secondary angles θ with the same absolute value.

According to the invention, the angle of inclination δ between the axis of the conduit 90 and the longitudinal axis X of the groove 3 is nonzero and is inclined such that the airflow near the friction surface 26 of the lining 2 is not perpendicular to the friction surface. In particular, the angle of inclination δ is not perpendicular to the plane H of the friction surface 26. In fact, in this case (primary angle β=90° and secondary angle θ=0) the airflow created in the groove 3 has a longitudinal velocity near the friction surface 26 which is not maximal, and the transverse velocity of this airflow (velocity in a direction perpendicular to the longitudinal axis X near the friction surface 26) is zero. This is therefore a case where the airflow near the friction surface 26 is not optimal.

Further, the tests done by the inventor show that the total velocity distribution (the total velocity is the vector sum of the longitudinal velocity and transverse velocity) is maximal and essentially along the friction surface 26 when the secondary angle θ is included in the interval [−15°, 15°] and the primary angle β is included in the angle [60°, 85°].

These tests also show that the transverse velocity of the airflow is non-negligible (meaning nonzero and of the same order of magnitude as the longitudinal velocity of the airflow) under two conditions:
A first configuration with a primary angle β less than 40° and a secondary angle θ outside of the interval [−10°, 10°].
A second configuration with a primary angle β greater than 40° and a secondary angle θ outside of the interval [−20°, 20°].

In a first embodiment, as shown in FIGS. 1 and 2, the conduit 90 opens near its inlet 911 on the lower edge 23.

Thus, in operation, the air passes from the inlet 911 through the conduit 90 to the outlet 922 and then in the groove 3 to the aspiration hole 17, then in the hose 40, which allows the evacuation of particles and dust 28 present in the air. This circulation of the air is specific to the case shown in FIGS. 1 to 5.

The conduit 90 has a constant circular section. Alternatively, the conduit 90 has a noncircular section, and/or a variable section.

Advantageously, the inlet 911 opens in the zone of the inner edge 23 (or in the general case one of the edges (21, 22, 23, 24) of the lining 2) which is closest to the backing plate 1 and which is not consumed at the end of the normal operating time (lifetime) of the pad 10. The inlet 911 therefore opens at a distance from the inner surface 13 of the backing plate 1 which is greater than the residual height of the lining 2 (see above).

Thus, all during the life of the pad 10, the section of the conduit 90 remains constant, and the performance for aspiration of the particles 28 by the collection groove is maintained.

When a conduit 90 is located at a height equal to this residual height, the conduit 90 plays a role of visual wear indicator. In fact, reaching the conduit 90 by wear of the lining 2 indicates that the pad 10 has reached its end of life.

In other embodiments, as shown in FIGS. 3 and 5, the conduit 90 does not open near its inlet 911 on the lower edge 23. In contrast, the conduit 90 passes through the backing plate 1 from the collection groove 3 so as to open near its inlet 911 on the backing plate 1. This solution has the advantage that the conduit 90 may be drilled in the backing plate 1 during the fabrication thereof, and it is not necessary to form the conduit 90 in the lining 2. The fabrication of the pad 10 is therefore simplified and the cost thereof is reduced. The outlet 922 is always located near the inner surface 13 of the backing plate 1.

In one of these embodiments (second one), as shown in FIG. 3, the inlet 911 opens on the lateral edge 11 of the backing plate 1. The primary angle β is then necessarily strictly less than 90°.

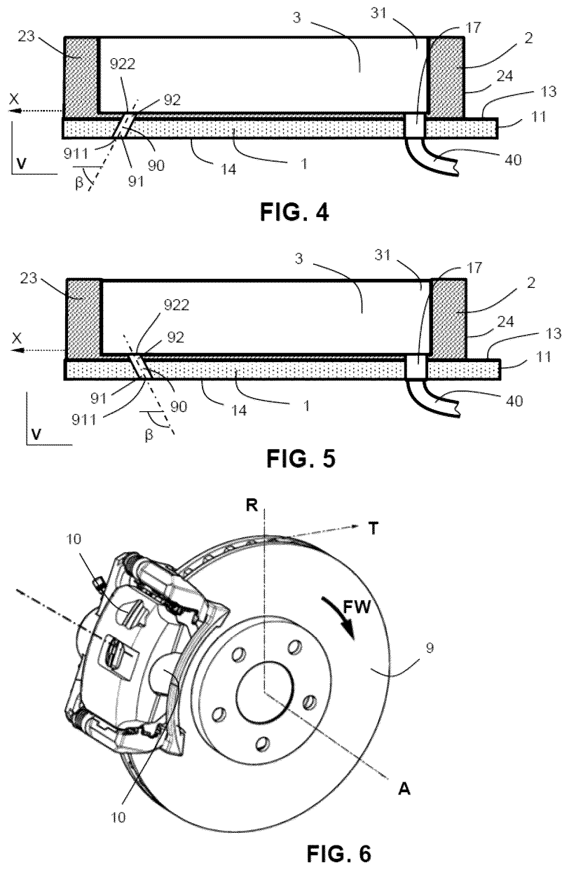

In another of these embodiments (third one), as shown in FIGS. 4 and 5, the inlet 911 opens on the outer surface 14 of the backing plate 1. The primary angle β is then necessarily strictly less than 180°. FIG. 4 shows the case where the primary angle β is included in the interval ]0°, 90°[. FIG. 5 shows the case where the primary angle β is included in the interval ]90°, 180°[.

In the embodiments described above and shown in FIGS. 2 to 5 and 7, the axis of the conduit 90 is located in the plane V of the groove 3. The secondary angle θ is therefore zero.

In another embodiment, the axis of the conduit 90 makes a secondary angle θ with the longitudinal axis X of the groove 3 that is nonzero and included between −90° and 90°.

This other embodiment is shown in FIG. 8 (b) from FIG. 8 in the case where the secondary angle θ is equal to 45°, and in FIG. 8 (c) from FIG. 8 in the case where the secondary angle θ is equal to 90°. For reference, FIG. 8 (a) from FIG. 8 shows the case where the secondary angle θ is equal to 0°. The angle of inclination δ is then equal to the primary angle β. In FIG. 8, in the three cases (a), (b) and (c), the primary angle β is equal to 45°, as an example.

This other embodiment has an additional advantage compared to the embodiment where the secondary angle θ is zero. In fact, the particles created by friction between the lining and the disk (or wheel) of the vehicle are naturally carried along the friction surface 26 transversely relative to the groove 3 (arrow 28 on FIG. 1). These particles therefore have a tendency to pass over the groove 3 without going into it and escaping into the atmosphere, which is a problem.

Unexpectedly, the tests done by the inventor showed that in the case where the secondary angle data is nonzero, it may create a transverse airflow (in a direction perpendicular to the longitudinal axis X) with vortices near the friction surface 26 which is directed in the direction opposite the flow (arrow 28) of these particles. Such an airflow thus contributes to blocking the escape of particles out of the groove 3.

Such a transverse airflow which contributes to blocking the escape of particles out of the groove 3 is more specifically created when the secondary angle θ is negative. In particular, such an airflow is created when the secondary angle θ is included in the interval [−80°, −10°]. FIG. 9 shows the airflow in the example where the primary angle β is equal to 45° and the secondary angle θ is equal to −50°. The arrow P1 shows the direction of the majority of the airflow, in particular near the friction surface 26. It can be seen that this flow goes in the opposite direction from the flow of the particles along the friction surface (the arrow P1 is in the same line and opposite direction from the arrow 28). Thus, the airflow coming from the conduit 90 contributes to making the particles enter into the groove 3. The tests done by the inventor show that the lateral velocity of this airflow is maximal for a primary angle β in the interval [25°, 75°] and a secondary angle θ in the interval [−50°, −25°].

For some positive values of the secondary angle θ, experiments done by the inventor show that it creates near the friction surface 26 a transverse airflow which does not block the escape of particles out of the groove 3 or which enhances this escape. These values of the secondary angle θ therefore correspond to an unfavorable situation. FIG. 10 shows the example where the primary angle β is equal to 45° and the secondary angle θ is equal to 45°. The arrow P2 shows the direction of the majority of the airflow, in particular near the friction surface 26. It can be seen that this flow goes in the same direction as the flow of the particles along the friction surface (the arrow P2 is in the same line and same direction as the arrow 28). Thus, the airflow coming from the conduit 90 contributes to carrying the particles out into the groove 3.

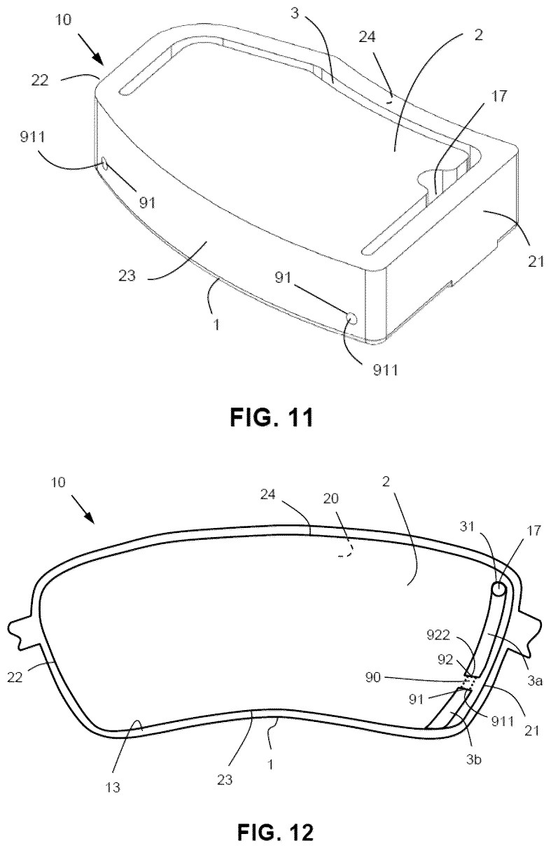

Now, yet another embodiment of the invention is described with reference to FIG. 11. FIG. 11 shows a brake pad in the railway domain.

The collection groove 3 is a single C-shaped groove which follows along the rear edge 21 and the front edge 22. The central portion of the collection groove 3 follows along the outer edge 24 and connects the front portion and rear portion of the collection groove 3. The rear portion (which follows along the rear edge 21) of the collection groove 3 is extended near the first end thereof by a conduit 90 which opens from the side of the inner edge 23. The front portion (which follows along the front edge 22) of the collection groove 3 is extended near the second end thereof by another conduit 90 which opens from the side of the inner edge 23.

Each of these conduits 90 is similar to one of the conduits 90 which was described with reference to FIGS. 1 to 5. Alternatively, each of these two conduits 90 has a different geometry from the other conduit 90, for example, different sections so as to balance the flow rates.

The backing plate 1 comprises a through aspiration hole 17 which opens into the rear portion of the groove 3, as shown in FIG. 11. The groove 3 in it is widened (the groove 3 may also not be widened in this area). Alternatively, the aspiration hole 17 opens into the front portion or into the central portion of the groove 3. In every case, the aspiration hole 17 is located away from the ends of the collection groove 3.

In the above embodiments, the lining 2 is provided with a single groove 3.

In yet another embodiment of the invention, the lining 2 is provided with a plurality of disjoint collection grooves 3. The following configurations are then possible:

In a first configuration, at least one conduit 90 opens at the inner end 92 thereof into one end of one of the grooves 3 and opens at the outer end 91 thereof from the side of one of the edges (21, 22, 23, 24) of the lining 2.

In a second configuration, at least one conduit 90 opens at the inner end 92 thereof into one end of one of the grooves 3 and opens at the outer end 91 thereof into an end of another of the grooves 3.

In a third configuration, which is a combination of the first configuration and a second configuration, at least one conduit 90 opens at the inner end 92 thereof in one end of one of the grooves 3 and opens at the outer end 91 thereof from the side of one of the edges (21, 22, 23, 24) of the lining 2, and at least one other conduit 90 opens at the inner end 92 thereof into an end of one of the grooves 3 and opens at the outer end 91 thereof into an end of another of the grooves 3.

FIG. 12 shows an example of the second configuration in the case where the lining 2 is provided with only two disjoint collection grooves 3, specifically a first groove 3a and a second groove 3b. The first groove 3a and the second groove 3b are in the extension of each other and extend along the rear edge 21. A single conduit 90 extends between a first end of the first groove 3a and a first end of the second groove 3b.

Thus the conduit 90 opens at the outer end 91 thereof into the second groove 3b by an inlet 911. The conduit 90 opens at the inner end 92 thereof in the first groove 3a by an outlet 922. The outlet 922 is located at the first end of the first groove 3a.

The second end of the first groove 3a is a blind end 31, which does not open on the outer edge 24. Near this blind end 31, the backing plate 1 comprises a through aspiration hole 17 which opens in the groove 3.

The second end of the second groove 3b opens on the inner edge 23.

1.-10. (canceled)

11. A brake pad comprising:
a backing plate with an outer surface, an inner surface and a lateral edge; and
a lining of friction material fixed to the inner surface, wherein the lining is delimited by a friction surface, an attachment surface, and a lateral edge formed of an inner edge, an outer edge, a rear edge, and a front edge, wherein the lining comprises:
at least one collection groove open to the friction surface and located at least in part near the rear edge, the at least one collection groove comprising a longitudinal axis,
wherein the backing plate comprises at least one aspiration hole in fluid communication with said at least one collection groove, wherein said at least one aspiration hole is connectable to a vacuum source to create an airflow, wherein the at least one collection groove is extended at at least one of an end thereof by a conduit, the conduit comprising:
an inlet opened outside said friction;
an outlet opened in the at least one collection groove, the outlet forming a section break with said at least one groove such that there exists, in operation, a reduced pressure between said inlet of the conduit and said at least one collection groove through said conduit; and
an axis,
wherein an angle of inclination between the axis of the conduit and the longitudinal axis of the at least one collection groove is nonzero and is such that in operation the airflow near the friction surface of the lining is not perpendicular to the friction surface.

12. The brake pad of claim 11, wherein the friction surface defines a plane, wherein the angle of inclination is broken down into a primary angle in a plane perpendicular to the plane of the friction surface and a secondary angle within the plane of the friction surface, wherein said primary angle is measured positively from said plane of the friction surface towards the backing plate outside of the at least one collection groove and around said outlet, and wherein said primary angle is included in the interval ]0°, 135°].

13. The brake pad of claim 12, wherein the secondary angle is zero.

14. The brake pad of claim 13, wherein the outlet opens on the lateral edge of the lining.

15. The brake pad of claim 13, wherein the conduit passes through the backing plate, wherein the outlet opens one of: the outer surface of the backing plate; and the lateral edge of the backing plate.

16. The brake pad of claim 11, wherein the at least one collection groove comprises a single collection groove which follows said rear edge.

17. The brake pad of claim 16, wherein the single collection groove further follows the front edge.

18. The brake pad of claim 17, wherein the single collection groove comprises one of: a C shape; an E shape; or a circumferential shape, and wherein the single collection groove follows along the outer edge and/or the inner edge of the lining.

19. The brake pad of claim 11, wherein the friction surface defines a plane, wherein the angle of inclination is broken down into a primary angle in a plane perpendicular to the plane of the friction surface and a secondary angle within the plane of the friction surface, wherein the secondary angle is comprised between −90° and 90°, zero excluded.

20. The brake pad of claim 19, wherein the secondary angle is negative.
